(19) United States
(12) Patent Application Publication
(10) Pub. No.: US 2026/0259385 A1
(43) Pub. Date: Sep. 3, 2026

(54) STRAIN-MODIFIED OPTICAL FIBER CABLE

(71) Applicant: OFS Fitel, LLC, Norcross, GA (US)

(72) Inventors: Robert S Dyer, East Granby, CT (US); Tristan Kremp, Somerset, NJ (US); Jie Li, Unionville, CT (US); Brian Savran, Canton, CT (US); Brian Violette, East Granby, CT (US)

(73) Assignee: OFS Fitel, LLC, Norcross, GA (US)

(21) Appl. No.: 18/993,691

(22) PCT Filed: Jul. 12, 2022
(86) PCT No.: PCT/US22/36858

§ 371 Date: Jan. 13, 2025

(51) Int. Cl. G02B 6/44; G01L 1/24

(52) U.S. Cl. CPC G02B 6/4429; G01L 1/242; G02B 6/4479

(57) ABSTRACT

A strain-compensated optical cable comprises a strength member extending substantially along a length of the optical cable. The optical cable has a first buffer tube and a second buffer tube, both of which extend along the length of the optical cable. Positioned within the first buffer tube is a strain-measuring single-mode fiber (SMF). Positioned within the second buffer tube is a hollow-core fiber (HCF). The SMF is used as a means for measuring strain (ϵ), thereby allowing for strain mitigation experienced by the HCF. A stranding material extends substantially along the length of the optical cable and strands together the first buffer tube and the second buffer tube. An outer jacket surrounds the stranding material and extends substantially along the length of the optical cable.

### BACKGROUND

### Field of the Disclosure

The present disclosure relates generally to fiber optics and, more particularly, to optical fiber cables.

### Description of Related Art

An optical fiber cable (also called an optical cable) is typically designed to protect optical fibers that reside within the cable. Sometimes, performance of an optical fiber is influenced by strain that the optical fiber experiences.

### SUMMARY

The present disclosure provides systems and processes associated with strain-compensated optical fiber cables (or optical cables).

Briefly described, in architecture, one embodiment of the optical cable comprises a strength member extending substantially along a length of the optical cable. The optical cable has a first buffer tube and a second buffer tube, both of which extend along the length of the optical cable. Positioned within the first buffer tube is a strain-measuring single-mode fiber (SMF). Positioned within the second buffer tube is a hollow-core fiber (HCF). A stranding material extends substantially along the length of the optical cable and strands together the first buffer tube and the second buffer tube. An outer jacket surrounds the stranding material and extends substantially along the length of the optical cable. The strain-measuring SMF permits strain measurements during manufacturing of the optical cable. The strain measurements permit controlled adjustments to strain at various points in the cable-manufacturing process, thereby reducing strain on the HCF.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a drawing of a cross-sectional view of one embodiment of an optical cable.

FIG. 2 is a flowchart showing one embodiment of a manufacturing process for a strain-sensitive optical cable.

FIG. 3 is a sample Optical Spectrum Analyzer (OSA) trace for a conventional hollow-core fiber (HCF) that was manufactured without compensating for strain at various points during the manufacturing process.

FIG. 4 is a sample OSA trace for one embodiment of a HCF that was manufactured using one embodiment of strain compensation as taught herein.

FIG. 5 is a graph showing strain (in microstrain (μϵ)) as a function of distance (in meters (m)) for the conventional HCF shown in FIG. 3.

FIG. 6A is a graph showing strain (in μϵ) as a function of distance (in m) for one embodiment of a HCF that was manufactured using strain compensation as taught herein.

FIG. 6B is a graph showing strain (in μϵ) as a function of distance (in m) for another embodiment of a HCF (namely, from a different lot) that was manufactured using strain compensation as taught herein.

FIG. 6C is a graph showing strain (in μϵ) as a function of distance (in m) for yet another embodiment of a HCF (namely, from yet another lot) that was manufactured using strain compensation as taught herein.

### DETAILED DESCRIPTION OF THE EMBODIMENTS

An optical fiber cable (also called an optical cable) is typically designed to protect optical fibers that reside within the cable. Performance of some optical fibers is influenced by strain that the optical fiber experiences. For example, strain in a hollow-core fiber (HCF) increases attenuation as well as unwanted coupling between modes within a core of the HCF. Sometimes, unwanted strain is induced into an optical fiber during a cabling process, with the unwanted strain being sufficiently high that the product no longer satisfies quality requirements for fiber-optic cables.

Also, both strain and the fiber properties contribute to attenuation effects. Thus, disentangling the two effects can be difficult if only the measured attenuation values are considered after complete manufacturing of the optical cable.

Finally strain-induced attenuation can be both direct and indirect. By way of example, an optical fiber can experience an indirect strain-induced wavelength-dependent attenuation when the wavelength is spectrally shifted by strain.

To de-couple attenuation from cable-processing strain and attenuation from fiber properties, this disclosure teaches optical cables and manufacturing processes that measure and appropriately compensate for strain during the cable manufacturing process.

Specifically, for some embodiments, strain is measured at different points during the cable manufacturing process, thereby allowing for strain compensation during processing steps that follow the strain measurement.

Generally, one embodiment of an optical cable comprises a strength member that extends substantially along a length of the optical cable. The optical cable has a first buffer tube and a second buffer tube, both of which extend along the length of the optical cable. The first buffer tube has a strain-measuring single-mode fiber (SMF), while the second buffer tube has a hollow-core fiber (HCF). The strain-measuring SMF permits strain measurements at various points in the optical cable manufacturing process, which in turn permits adjustment of manufacturing parameters in subsequent steps, thereby permitting compensation for process-induced strain.

Having provided a broad technical solution to a technical problem, reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

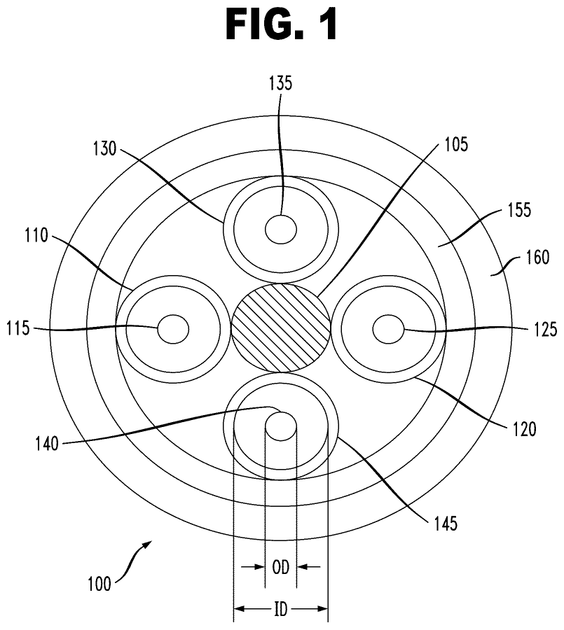

Turning to the drawings, FIG. 1 shows one embodiment of an optical cable 100 for compensating for strain during cabling. As shown in FIG. 1, the optical cable 100 comprises a strength member 105, which extends substantially along a length of the optical cable 100.

The optical cable 100 further comprises a first buffer tube 110 that also extends substantially along the length of the optical cable 100. The first buffer tube 110 extends substantially alongside the strength member 105. For later reference, the first buffer tube comprises a first length and a first tube inner diameter (ID).

Positioned within the first buffer tube 110 is a first strain-measuring single-mode fiber (SMF) 115, which extends substantially along the length of the optical cable 100. The first strain-measuring SMF 115 comprises a first SMF fiber length that is longer than the first tube length, thereby providing an excess fiber length (EFL) within the first buffer tube 110. The first strain-measuring SMF 115 also has a first SMF fiber outer diameter (OD) that is smaller than the first tube ID, which provides space for the units to expand and contract during manufacturing without applying undue stress or strain on the first strain-measuring SMF 115. In a completed optical cable 100, the strain on the first strain-measuring SMF 115 is measured to be between +100 microstrain (μϵ) and −100 μϵ (with μϵ being 10⁻⁶ and designated without formal units because strain is a dimensionless relative quantity).

The optical cable 100 further comprises a second buffer tube 120 with a second strain-measuring SMF 125. Similar to the first buffer tube 110, the second buffer tube 120 extends substantially along the length of the optical cable 100 and alongside the strength member 105. The second buffer tube 120 has a second length and a second ID.

Within the second buffer tube 120 is a second strain-measuring SMF 125, which extends substantially along the length of the optical cable 105. Again, to provide sufficient space for expansion and contraction during manufacture, the second strain-measuring SMF 125 comprises a second SMF fiber length that is longer than the second tube length, thereby providing an EFL within the second buffer tube 120. Also, the second strain-measuring SMF 125 has a second SMF fiber OD that is smaller than the second tube ID to permit the units to expand and contract during manufacturing without applying undue stress or strain on the second strain-measuring SMF 125. On a completed optical cable 100, the strain on the second strain-measuring SMF 125 is measured to be between +100 μϵ and −100 μϵ.

Between the first strain-measuring SMF 115 and the second strain-measuring SMF 125, the optical cable 100 provides at least two (2) means for measuring strain in the optical cable 100 at various points during the manufacturing process.

Continuing, the optical cable 100 further comprises a third buffer tube 130 that also extends substantially along the length of the optical cable 100 and substantially alongside the strength member 105. The third buffer tube 130 comprises a third tube length and a third tube ID.

A first hollow-core fiber (HCF) 135 is positioned within the third buffer tube 130. The first HCF 135 extends substantially along the length of the optical cable 100 and comprises a first HCF fiber length that is longer than the third tube length, thereby providing an EFL within the third buffer tube 130. Also, the first HCF 135 comprises a first HCF fiber OD that is smaller than the third tube ID. The EFL and the space between the fiber OD and the tube ID permit the unit to expand and contract during manufacture without inducing substantial stress or strain on the first HCF 135.

The optical cable 100 further comprises a fourth buffer tube 140 that extends along the length of the optical cable 100. Similar to the other buffer tubes 110, 120, 130, the fourth buffer tube 140 extends substantially alongside the strength member 105. The fourth buffer tube 140 has a fourth tube length and a fourth tube ID.

A second HCF 145, which is positioned within the fourth buffer tube 140, extends substantially along the length of the optical cable 100. The second HCF comprises a HCF fiber length that is longer than the fourth tube length and a HCF fiber OD that is smaller than the fourth tube ID. Again, the EFL and the space between the fiber OD and the tube ID permit expansion and contraction of the unit without inducing substantial stress or strain on the second HCF 145. Those having skill in the art will appreciate that a jacket (not shown) may optionally be applied to the buffer tubes 110, 120, 130, 140, with each optional jacket including one or more aramid strands or other strength members to improve structural strength.

Due to the geometrical properties of the buffer tubes 110, 120, 130, 140 and the strength member 105, an interstitial space 150 exists between the buffer tubes 110, 120, 130, 140. Next, the optical cable 100 comprises a stranding material 155, which surrounds the first buffer tubes 110, 120, 130, 140 and the interstitial space 150. As is known in the art, the stranding material 155 adds strength to the optical cable 100 and keeps organized the buffer tubes 110, 120, 130, 140 in relation to the strength member 105.

Lastly, the optical cable 100 comprises an outer jacket 160 that surrounds the stranding material 155 and extends substantially along the length of the optical cable 100. As understood by those having ordinary skill in the art, some embodiments include aramid strands or other strength members that are positioned between the stranding material 155 and the outer jacket 160, thereby improving strength characteristics of the optical cable 100.

Ultimately, the optical cable 100 comprises strain-measuring SMFs 115, 125 for troubleshooting and maintenance during the cable-manufacturing process, the installation process, or both. If the strain experienced by the strain-measuring SMFs 115, 125 during cable manufacture is indicative of the strain experienced by the HCFs 135, 145 during cable manufacture, then much of the manufacturing-process-induced strain on the HCFs 135, 145 can be estimated from the measured strains on the strain-measuring SMFs 115, 125. This permits adjustment at various points in the cable-manufacturing process, thereby resulting in optical cables with fibers 115, 125, 135, 145 that exhibit between +100 μϵ and −100 μϵ when the optical cable manufacturing process is completed.

In other words, by measuring the process-induced strains on the strain-measuring SMFs 115, 125 and adjusting the manufacturing process in response to the measured strains, the end product (namely, the manufactured and ready-to-ship optical cable 100) will preferably have HCFs 135, 145 that exhibit strain that is within ±100 μϵ.

Although two (2) strain-measuring SMFs 115, 125 and two (2) HCFs 135, 145 are shown in FIG. 1, it should be appreciated that any number of strain-measuring SMFs (including a single strain-measuring SMF) and any number of HCFs can be used without detrimentally affecting the performance of the optical cable 100. As long as the presumption remains valid (that all fibers experience substantially similar manufacturing-process-related strains), a single strain-measuring SMF should sufficiently reflect the strains imparted on all fibers during the manufacturing process. The two-SMF embodiment (as shown in FIG. 1) provides redundancy.

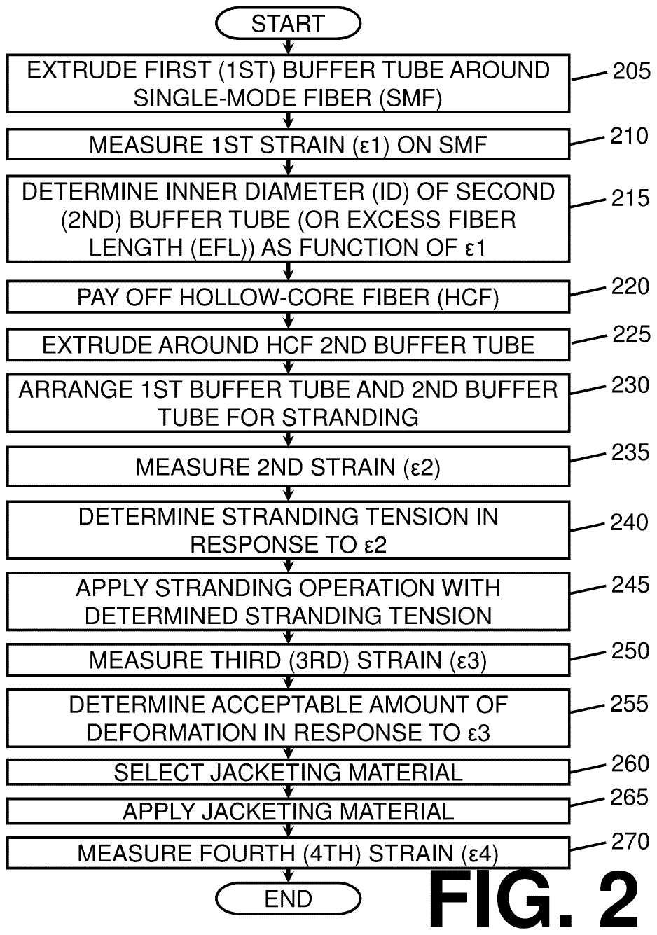

Turning now to one embodiment of an optical cable manufacturing process, FIG. 2 shows a flowchart for one embodiment of a manufacturing process with strain measurements at various points during the manufacturing process.

As shown in FIG. 2, one embodiment of the process starts with extruding 205 a first buffer tube around a single-mode fiber (SMF). For some embodiments, the extruding 205 step is conventional and can be done by many different prior-art methods.

Upon extruding 205 the first buffer around the SMF the process measures 210 a first strain (ϵ1) experienced by the SMF. For some embodiments, the ϵ1 is measured 210 using known techniques, such as Brillouin Optical Time Domain Reflectometry (BOTDR) or Brillouin Optical Time Domain Analysis (BOTDA). It should be appreciated that other known techniques can be used to measure 210 the ϵ1. Preferably, ϵ1 is between +100 μϵ and −100 μϵ (also designated as being between ±100 μϵ).

Based on ϵ1, the process determines 215 an inner diameter (ID) of a second buffer tube. In other words, the ID of the second buffer tube is a function of the measured ϵ1. Because the ϵ1 reflects the strain that the SMF experiences as a result of the extrusion 205 step, the ID determination 215 is responsive to and follows the extrusion 205 step. Specifically, if the ϵ1 on the SMF is determined to be higher than expected or acceptable, then the ID is increased (e.g., from 0.5 mm to 0.6 mm) to provide more space between the fiber and the inner diameter of the buffer tube to reduce strain effects from expansion or contraction during the manufacturing process.

As an alternative to determining 215 the appropriate ID, the process can determine an appropriate amount of excess fiber length (EFL). For example, if the process determines that there is too much tensile strain, then a longer EFL is provided to compensate for the additional tensile strain. Conversely, if the process determines that there is too much compressive strain, then a shorter amount of EFL may be sufficient.

Next, the process pays off 220 a HCF and extrudes 225 around the paid-off HCF the second buffer tube with the determined 215 ID (or with the appropriate amount of EFL). As noted above, because an appropriate ID (and/or EFL) has been determined 215 from the measured 210 ϵ1, there is at least a partial compensation for strain when the HCF is being paid off 220 and the second buffer tube is being extruded 225 around the HCF.

Continuing in FIG. 2, the first buffer tube and the second buffer tube are arranged 230 for stranding and, thereafter, a second strain (ϵ2) is measured 235 using the SMF. From the measured ϵ2, the process determines 240 a stranding tension. Preferably, the determined 240 stranding tension strikes a balance between a high enough tension to maintain structural integrity of the optical cable and a low enough tension to avoid both manufacturing-process-induced strain on the HCF and inadvertent reduction in EFL. Once the appropriate stranding tension is determined 240, a conventional stranding operation is applied 245 using that stranding tension.

Upon stranding, a third strain (ϵ3) is measured 250 and an acceptable amount of deformation is determined 255 in response to the measured 250 ϵ3. The measured 250 ϵ3 reflects a cumulative strain on the cable subunits through the applied 245 stranding operation, thereby providing some indication of how much more strain is acceptable for the remainder of the cabling process. Typically, ϵ3 is within the ±100 μϵ and, thus, any remaining steps in the cabling process should preferably maintain, rather than adversely affect, the strain value.

With this in mind, based on how much more strain is acceptable, a jacket material is selected 260. One having ordinary skill in the art will appreciate that, because ϵ3 should reflect an acceptable level of strain, an important consideration in a final jacketing process is to avoid adding strain.

Upon selecting 260 the appropriate jacketing material, the process applies 265 the jacketing material, thereby completing the jacketing step. For some embodiments, a fourth strain (ϵ4) is measured 270, which reflects the final manufacturing-process-induced strain experienced by the optical cable. Preferably, each of the process induced strains ϵ1, ϵ2, ϵ3, and ϵ4 are between ±100 μϵ.

Also, similar to how ϵ1 can be measured using BOTDR/BOTDA, the other strain measurements (for ϵ2, ϵ3, and ϵ4) can also be measured using BODTR/BOTDA. As one having ordinary skill in the art will appreciate, any known method for measuring strain using SMFs can be employed in conjunction with or in place of the disclosed strain-measuring process.

In some embodiments, not all of the steps shown in FIG. 2 are necessary all of the time for all manufactured cables. Preferably, the process of FIG. 2 is implemented multiple times over different cables until a strain level that is within ±100 μϵ is consistently observed. Upon reaching a substantially consistent outcome of ±100 μϵ, the cable manufacturing parameters for achieving that substantially consistent outcome are used as the manufacturing parameters. Thus, for subsequently manufactured optical cables, the process need not measure each strain value at each processing step but, instead, can intermittently measure strain at various points in the process as a spot-check or as a quality-control assessment.

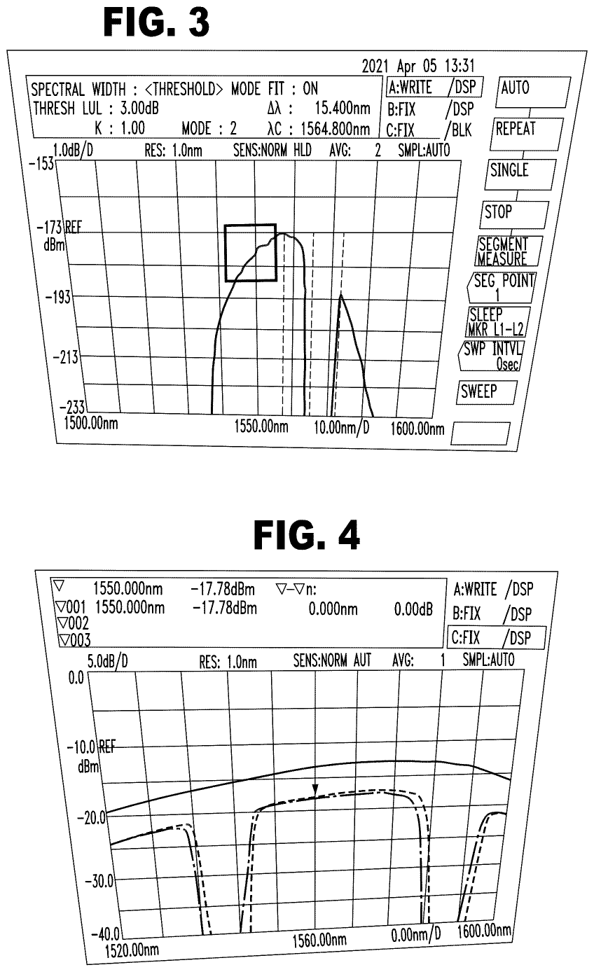

With the cable 100 of FIG. 1 and the process of FIG. 2 in mind, attention is turned to FIGS. 3, 4, 5, 6A, 6B, and 6C which compare: (a) a HCF manufactured without compensating for strain at during various points in the cable-manufacturing process (also designated as conventional cables); and (b) a HCF that considered process-induced strains during various points in the cable-manufacturing process (also designated as strain-compensated cables).

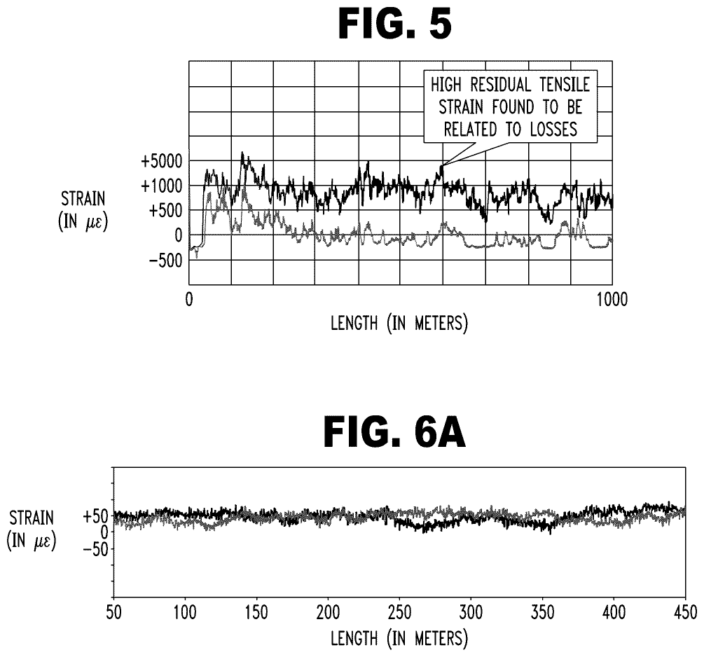

As shown in FIGS. 3 and 5, the sample Optical Spectrum Analyzer (OSA) trace and strain-loss profile of a conventionally manufactured optical cable shows that values of strain appear to be variant and asymmetric (meaning, the strain is not symmetric about zero (0) but, rather offset from 0). Furthermore, from the measured strain over distance, the conventionally manufactured cable shows strain values that are relatively high, namely, between +500 μϵ and +1500 μϵ. In other words, the conventionally manufactured optical cable exhibits both a higher strain value (above +500 μϵ) as well as a larger strain range (1000 μϵ (between +500 and +1500)).

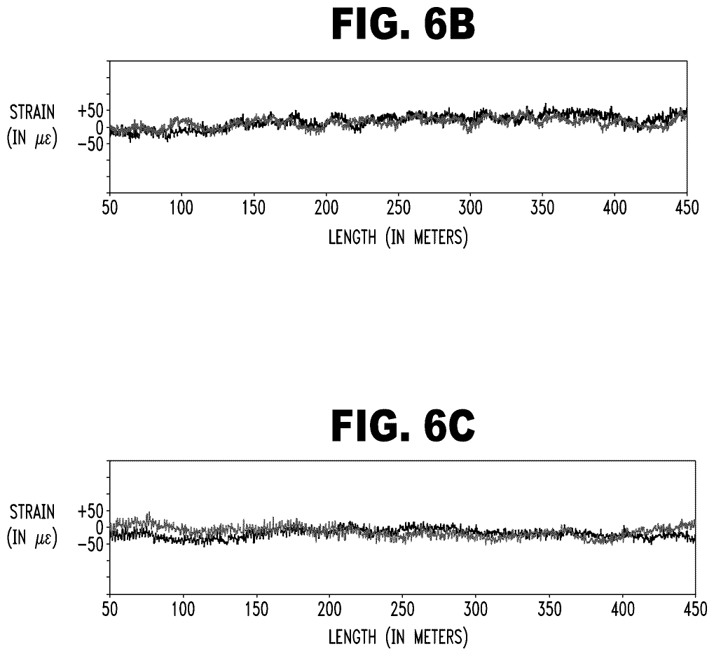

Next, FIG. 4 shows a sample OSA trace for a HCF that was manufactured using one embodiment of strain compensation as taught herein. Also, FIGS. 6A, 6B, and 6C (collectively designated as FIG. 6) show strain-loss profiles for at least three (3) physically different optical cables that were manufactured using one embodiment of the strain-compensation process shown in FIG. 2.

Comparing FIGS. 4 and 6 with FIGS. 3 and 5, the strain-compensated cables appear to exhibit a more symmetric strain (meaning, the strain is substantially centered about 0) and a much smaller range of strain values. Specifically, as shown in FIG. 6, the strain values are within ±100 μϵ. Some embodiments even exhibited strains within ±50 μϵ. In other words, the strain-compensated optical cables exhibited a five-fold improvement over conventional optical cables that were not compensated for strain during the manufacturing process.

As seen from FIGS. 1 through 6, by measuring strain at various points during the optical cable manufacturing process, one can more-readily disentangle cable-induced strain performance impacts and fiber-only performance impacts. By separating these effects, one can reduce unwanted strain from the manufacturing process from being induced into the optical fibers. For optical fibers where the optical performance is heavily influenced by the strain that the fiber experiences during its operation lifetime (e.g., temperature sensing fibers, polarization maintaining fibers, hollow-core fibers, etc.), reducing the residual strain from the cable-manufacturing process results in a higher-quality optical cable. Additionally, other strain-related effects that degrade optical properties can be mitigated to some extent by compensating for manufacturing-process-related strains.

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

Although exemplary embodiments have been shown and described, it will be clear to those of ordinary skill in the art that a number of changes, modifications, or alterations to the disclosure as described may be made. All such changes, modifications, and alterations should therefore be seen as within the scope of the disclosure.

What is claimed is:

1. An optical cable comprising:
a strength member extending substantially along a length of the optical cable;
a first buffer tube extending along the length of the optical cable, the first buffer tube further extending substantially alongside the strength member, the first buffer tube comprising:
a first tube length;
a first tube inner diameter (ID);
a first strain-measuring single-mode fiber (SMF) extending substantially along the length of the optical cable, the first strain-measuring SMF being positioned within the first buffer tube, the first strain-measuring SMF comprising:
a first SMF fiber length that is longer than the first tube length;
a first SMF fiber outer diameter (OD) that is smaller than the first tube ID; and
a first measurable strain between +100 μϵ and −100 μϵ;
a second buffer tube extending along the length of the optical cable, the second buffer tube further extending substantially alongside the strength member, the second buffer tube comprising:
a second tube length; and
a second tube ID;
a second strain-measuring SMF extending substantially along the length of the optical cable, the second strain-measuring SMF being positioned within the second buffer tube, the second strain-measuring SMF comprising:
a second SMF fiber length that is longer than the second tube length;
a second SMF fiber OD that is smaller than the second tube ID; and
a second measurable strain between +100 μϵ and −100 μϵ;
a third buffer tube extending along the length of the optical cable, the third buffer tube further extending substantially alongside the strength member, the third buffer tube comprising:
a third tube length; and
a third tube ID;
a first hollow-core fiber (HCF) extending substantially along the length of the optical cable, the first HCF being positioned within the third buffer tube, the first HCF comprising:
a first HCF fiber length that is longer than the third tube length; and
a first HCF fiber OD that is smaller than the third tube ID;
a fourth buffer tube extending along the length of the optical cable, the fourth buffer tube further extending substantially alongside the strength member, the fourth buffer tube comprising:
a fourth tube length; and
a fourth tube ID;
a second HCF extending substantially along the length of the optical cable, the second HCF being positioned within the fourth buffer tube, the second HCF comprising:
a HCF fiber length that is longer than the fourth tube length; and
a HCF fiber OD that is smaller than the fourth tube ID;
a stranding material extending substantially along the length of the optical cable, the stranding material surrounding the first buffer tube, the second buffer tube, the third buffer tube, and the fourth buffer tube; and
an outer jacket extending substantially along the length of the optical cable, the outer jacket surrounding the stranding material.

2. An optical cable manufacturing process comprising:
extruding a first buffer tube around a single-mode fiber (SMF);
measuring a first strain (ϵ1) on the SMF, ϵ1 being dependent on the extruded first buffer tube;
determining, in response to the measured ϵ1, an inner diameter (ID) of a second buffer tube or an excess fiber length (EFL);
paying off a hollow-core fiber (HCF);
extruding around the paid-off HCF the second buffer tube with the determined ID or with the determined EFL;
arranging the first buffer tube and the second buffer tube in preparation for stranding;
measuring a second strain (ϵ2) on the SMF;
determining a stranding tension in response to the measured ϵ2; and
applying a stranding operation with the determined stranding tension.

3. The process of claim 2, further comprising:
measuring a third strain (ϵ3) on the SMF;
determining an acceptable amount of deformation in response to the measured ϵ3;
selecting a jacket material with material properties that correspond to the determined acceptable amount of deformation;
applying a jacketing operation using the selected jacket material; and
measuring a fourth strain (ϵ4) on the SMF.

4. The process of claim 3, wherein:
measuring the ϵ3 comprises measuring ϵ1 using Brillouin Optical Time Domain Reflectometry (BOTDR) or Brillouin Optical Time Domain Analysis (BOTDA); and
measuring the ϵ4 comprises measuring ϵ2 using BOTDR or BOTDA.

5. The process of claim 2, wherein:
measuring the ϵ1 comprises measuring ϵ1 using Brillouin Optical Time Domain Reflectometry (BOTDR) or Brillouin Optical Time Domain Analysis (BOTDA); and
measuring the ϵ2 comprises measuring ϵ2 using BOTDR or BOTDA.

6. The process of claim 2, wherein determining the EFL comprises determining an EFL that strains the HCF within ±100 μϵ during the extruding of the second buffer tube.

7. The process of claim 2, wherein determining the ID of the second buffer tube comprises determining the ID that strains the HCF within ±100 μϵ during the extruding of the second buffer tube.

8. The process of claim 2, wherein determining the stranding tension comprises determining the stranding tension that strains the HCF within ±100 μϵ during the applying of the stranding operation.

9. The process of claim 2, wherein determining the acceptable amount of deformation comprises determining the amount of deformation that maintains strains in the HCF to within ±100 μϵ during the applying of the jacketing operation.

10. An optical cable comprising:
a strength member extending substantially along a length of the optical cable;
a first buffer tube extending along the length of the optical cable;
a strain-measuring single-mode fiber (SMF) positioned within the first buffer tube;
a second buffer tube extending along the length of the optical cable;
a hollow-core fiber (HCF) positioned within the second buffer tube;
a stranding material extending substantially along the length of the optical cable; and
an outer jacket extending substantially along the length of the optical cable.

11. The optical cable of claim 10:
the first buffer tube comprising:
a first tube length; and
a first tube inner diameter (ID); and
the strain-measuring SMF comprising:
a first SMF fiber length that is longer than the first tube length;
a first SMF fiber outer diameter (OD) that is smaller than the first tube ID; and
a first measurable strain between +100 microstrain (μϵ) and −100 μϵ.

12. The optical cable of claim 11, wherein:
the second buffer tube comprises:
a second tube length; and
a second tube ID; and
the HCF comprises:
a HCF fiber length that is longer than the second tube length;
a HCF fiber OD that is smaller than the second tube ID; and
a HCF strain between +100 μϵ and −100 μϵ.

13. The optical cable of claim 10, the HCF being a first HCF, the optical cable further comprising:
a third buffer tube comprising:
a third buffer tube length; and
a third buffer tube inner diameter (ID); and
a second HCF positioned within the third buffer tube.

14. The optical cable of claim 13, the second HCF comprising:
a second HCF fiber length that is longer than the third tube length;
a second HCF fiber outer diameter (OD) that is smaller than the third buffer tube ID; and
a second HCF strain between +100 μϵ and −100 μϵ.

15. The optical cable of claim 13, the strain-measuring SMF being a first strain-measuring SMF, the optical cable further comprising:
a fourth buffer tube comprising:
a fourth buffer tube length; and
a fourth buffer tube ID; and
a second strain-measuring SMF positioned within the fourth buffer tube.

16. The optical cable of claim 15, the second strain-measuring SMF comprising:
a second SMF fiber outer diameter (OD) that is smaller than the second tube ID; and
a second measurable strain between +100 μϵ and −100 μϵ.
